(19) United States
(12) Patent Application Publication
(10) Pub. No.: US 2020/0367429 A1
(43) Pub. Date: Nov. 26, 2020

(54) Robot and Control Method Therefor

(71) Applicant: Suzhou Cleva Precision Machinery & Technology Co., Ltd., Suzhou City, Jiangsu Province (CN)

(72) Inventor: Lichao Yuan, Suzhou City, Jiangsu Province (CN)

(21) Appl. No.: 16/955,838

(22) PCT Filed: Dec. 17, 2018
(86) PCT No.: PCT/CN2018/121402

§ 371 Date: Jun. 19, 2020

(30) Foreign Application Priority Data
Dec. 20, 2017 (CN) 201711382794.2

(51) Int. Cl. A01D 34/00; B25J 9/16; G06Q 10/06

(52) U.S. Cl. CPC A01D 34/008; G06Q 10/06312; B25J 9/161

(57) ABSTRACT

A control method for a robot includes the following steps: receiving work plan data containing a work prohibited time period and updating same to a memory; storing the updated work plan data to the memory; calculating, according to a current time and the work plan data, the most recent work prohibited time period and the most recent work start time point; according to a relation between the most recent work prohibited time period and the most recent work start time point, arranging a time point to trigger a corresponding next step of work event; and controlling the robot to execute the corresponding next step of work event. By arranging the next step of work event according to a current time and work plan data, a work plan can be set inversely, the demands of different users are flexibly satisfied, and the setting operation is convenient.

### CROSS-REFERENCE TO RELATED PATENT APPLICATIONS

This application is a national stage of International Application No. PCT/CN2018/121402, filed on Dec. 17, 2018, which claims priority to CN Patent Application No. 201711382794.2, filed on Dec. 20, 2017. All of the aforementioned applications are hereby incorporated by reference in their entireties.

### TECHNICAL FIELD

The present disclosure relates to a robot, and more particularly, to a robot capable of automatically walking and performing work and a control method thereof.

### BACKGROUND

With the continuous progress of science and technology, various robots have started to gradually enter people's lives, such as automatic dust collectors and automatic lawn mowers. This kind of robot has a traveling device, a working device and an automatic control device, so that the robot can be separated from the operation of people, walk automatically, avoid obstacles intelligently, walk automatically and perform work in a certain range, meanwhile, the robot has safety detection, battery power detection and the like, so that when the energy storage device of the robot is insufficient, the robot can automatically return to a charging station device to be charged, and then can work continuously, and the robot is particularly suitable for cleaning places such as family courtyards and public green space as well as lawn trimming and maintenance. This kind of robot frees people from boring and time-consuming and labor-consuming housework such as house cleaning, lawn trimming and the like, thereby saving time of people, and bringing convenience to life of people.

At present, the work schedule time of the robot of the same type can be set only in a specified time period for operation. When the user is more concerned about prohibiting the working hours of the robot, since there is no function of reversely setting the work schedule, it can be only achieved by setting the robot to work for a specified time period for many times, so that the operation is inconvenient and the work schedule cannot be flexibly set as the user desires.

### SUMMARY

An objective of the present disclosure is to provide a robot, which can set a time period in which a user does not want the robot to work as a work prohibited time period according to the requirement of the user, so as to achieve reverse setting of a work schedule.

The present disclosure also provides a method for controlling a robot, which can achieve reverse setting of a robot work schedule.

In order to achieve the above object, the present disclosure provides a control method of a robot, comprising the steps of:

receiving work schedule data containing a work prohibited time period and updating the same to a memory;

storing the work schedule data updated to the memory;

calculating, according to the current time and the work schedule data, a latest work prohibited time period and a latest work start time point;

setting a time point to trigger a corresponding next work event according to the relation between the latest work prohibited time period and the latest work start time point; and

controlling the robot to execute the corresponding next work event.

As a further improvement of an embodiment of the present disclosure, the work schedule data further includes a robot work frequency.

As a further improvement of an embodiment of the present disclosure, the latest work prohibited time period is acquired based on the current time and the work prohibited time period.

As a further improvement of the embodiment of the present disclosure, in the step of calculating the latest work prohibited time periods, if the current time point is within a plurality of work prohibited time periods, the work prohibited time period in which the end time point of the work prohibited time period is farthest from the current time point is determined as the latest work prohibited time period.

As a further improvement of the embodiment of the present disclosure, in the step of calculating the latest work prohibited time period, if the current time point is before the work prohibited time period, the work prohibited time period in which the start time point of the work prohibited time period is closest to the current time point is determined as the latest work prohibited time period.

As a further improvement of an embodiment of the present disclosure, the latest work start time point is obtained according to the current time and the work frequency.

As a further improvement of an embodiment of the disclosure, in the step of calculating the latest work start time point, the work start time point which is after the current time point and is closest to the current time point is determined as the latest work start time point.

As a further improvement of an embodiment of the present disclosure, after the latest work prohibited time period and the latest work start time point are obtained, the control method further includes a step of determining whether the latest work start time point is within the latest work prohibited time period, if so, setting an end time point of the latest work prohibited time period to trigger a corresponding next work event as a work start event and waiting for an event trigger; if not, setting the end time point of the latest work prohibited time period to trigger the corresponding next work event as a continuous work event.

As a further improvement of an embodiment of the present disclosure, after the next work event is set to be a continuous work event, the control method further includes a step of triggering the continuous work event, first, judging whether the current state is to be finished, if so, starting the continuous work, and setting the state to be in work; if not, maintaining the current state.

As a further improvement of an embodiment of the present disclosure, after obtaining the latest work prohibited time period and the latest work start time point, the control method further includes a step of determining whether the latest work start time point is before the start time point of the latest work prohibited time period, if so, setting the latest work start time point to trigger a corresponding next work event as a work start event and waiting for an event trigger; if not, setting the start time point of the latest work prohibited time period to trigger the corresponding next work event as a work prohibited event.

As a further improvement of an embodiment of the present disclosure, after the next work event is set to be a work prohibited event, the control method further includes a step of triggering the work prohibited event, first, determining whether the current state is in work, if so, stopping working, and setting the state as the work to be completed; if not, maintaining the current state.

As a further improvement of an embodiment of the present disclosure, after the next work event is set as a work start event, the control method further includes a step of triggering the work start event, first, determining whether the current state is idle, if so, starting a new work, setting the state to be in work, clearing the event, and returning to the program for setting the next work event; if not, continuously judging whether the current state is in work, if so, maintaining the current state; if not, continuing the work, and setting the state to be in work.

The disclosure provides a robot, comprising a memorizer configured to store program instructions of the control method according to any one of the previous embodiments; and a processor configured to execute the program instructions.

The present disclosure further provides a robot including:

a wireless receiving module used for receiving work schedule data containing a work prohibited time period and updating the same to a memory;

a storage module used for storing the work schedule data updated to the memory;

an execution strategy generating module used for calculating, according to the current time and the work schedule data, a latest work prohibited time period and a latest work start time point, and setting a time point to trigger a corresponding next work event according to the relation between the latest work prohibited time period and the latest work start time point; and

a control module used for controlling the robot to execute the corresponding next work event.

As a further improvement of an embodiment of the present disclosure, the work schedule data further includes a robot work frequency.

As a further improvement of an embodiment of the present disclosure, the latest work prohibited time period is acquired based on the current time and the work prohibited time period.

As a further improvement of the embodiment of the present disclosure, if the current time point is in a plurality of work prohibited time periods, the execution strategy generating module determines the work prohibited time period in which the current time point is in the work prohibited time periods and the end time point of the work prohibited time period is farthest from the current time point as the latest work prohibited time period.

As a further improvement of the embodiment of the present disclosure, if the current time point is before the work prohibited time period, the execution strategy generating module determines the work prohibited time period in which the start time point of the work prohibited time period is closest to the current time point as the latest work prohibited time period.

As a further improvement of the embodiment of the present disclosure, the execution strategy generating module obtains the latest work start time point according to the current time and the work frequency.

As a further improvement of an embodiment of the present disclosure, the execution strategy generating module determines the work start time point that is after the current time point and is closest to the current time point as the latest work start time point.

As a further improvement of an embodiment of the present disclosure, the execution strategy generating module is further configured to determine whether the latest work start time point is within the latest work prohibited time period, and if so, setting the end time point of the latest work prohibited time period to trigger a corresponding next work event as a work start event and waiting for an event trigger; if not, setting the end time point of the latest work prohibited time period to trigger the corresponding next work event as a continuous work event.

As a further improvement of an embodiment of the present disclosure, the execution strategy generating module is further configured to determine whether the latest work start time point is before the latest work prohibited time period, and if so, setting the latest work start time point to trigger a corresponding next work event as a work start event and waiting for an event trigger; if not, setting the start time point of the latest work prohibited time period to trigger the corresponding next work event as a work prohibited event.

As a further improvement of the embodiment of the present disclosure, the control module is further configured to control the robot to perform one of maintaining the current state, starting to continue work, starting a new work or stopping working according to the corresponding next work event and the current state of the robot.

As a further improvement of an embodiment of the present disclosure, the execution strategy generating module obtains the current time through an RTC.

Compared with the prior art, the disclosure has the beneficial effects that: by setting the next work event according to the current time and the work schedule data, a work schedule can be set inversely, the demands of different users are flexibly satisfied, the setting operation is convenient, the occupied memory is small and the processing speed is higher.

### BRIEF DESCRIPTION OF THE DRAWINGS

FIG. 1 is a block diagram of the hardware architecture of a lawn mowing robot in a preferred embodiment of the present disclosure;

FIG. 2 is an initialization flow chart of the lawn mowing robot of FIG. 1;

FIG. 3 is a dataflow block diagram of the lawn mowing robot of FIG. 1;

FIG. 4 is a flow chart of the lawn mowing robot of FIG. 1 setting a work schedule through a mobile terminal;

FIG. 5 is a block diagram of a display interface of control software of the terminal device of FIG. 1 that sets the work schedule of the lawn mowing robot;

FIG. 6 is a block diagram of the display interface for the control software of the terminal device of FIG. 5 to set the work start times of “week” and “season”;

FIG. 7 is a block diagram of the display interface, for setting the work prohibited time, of the control software of the terminal device in FIG. 5;

FIG. 8 is a flow chart of the detailed steps between the reading of the RTC to obtain the current time and the setting of the next work event in FIGS. 2 and 4;

FIG. 9 is a flow chart of the robot control after the wait event in FIG. 8 is triggered.

### DETAILED DESCRIPTION

The present disclosure will be described in detail below with reference to specific embodiments shown in the accompanying drawings. These embodiments are not intended to limit the present disclosure, and structural, methodological, or functional changes by the skilled in the art in accordance with the embodiments are included within the scope of the present disclosure.

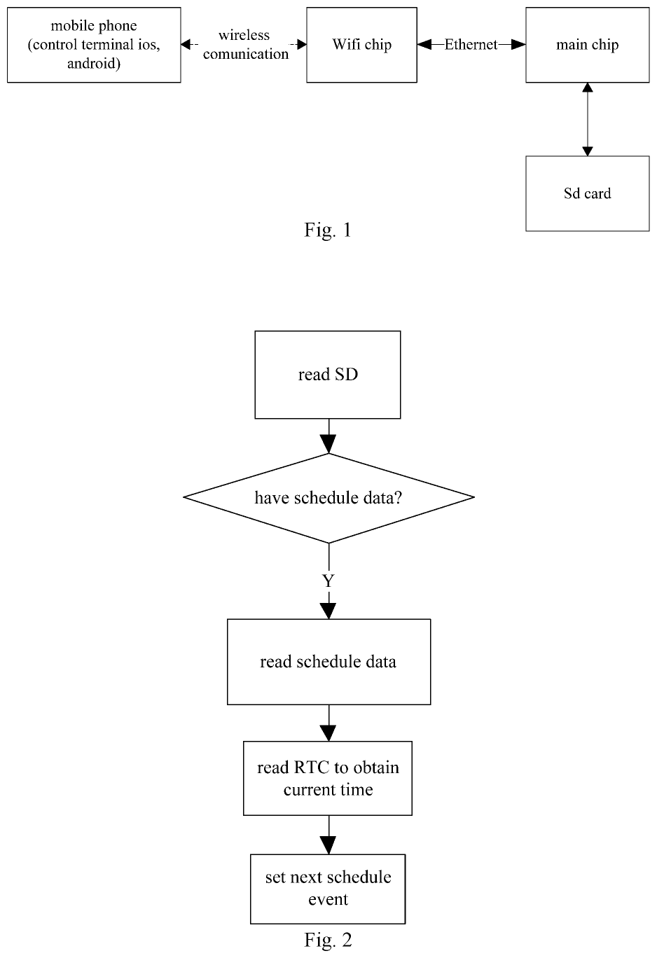

Referring to FIG. 1, preferably, the present disclosure is specifically described by taking a lawn mowing robot as an example, the lawn mowing robot is used for automatically walking and working on the ground, wherein walking and working energy is provided by using a cordless power supply, such as a battery pack, a solar panel and the like, and of course, a wired power supply can be connected with a mains supply for supplying power. The lawn mowing robot comprises a working module used for mowing the lawn and a walking module, wherein the walking module is used for walking and steering, and the working module is used for mowing the lawn. In addition, the lawn mowing robot further comprises a control module which is used for coordinating the working module and the walking module, and the control module can enable the lawn mowing robot to automatically walk on a lawn and mow under an unattended condition.

In the present embodiment, the lawn mowing robot further includes a wireless communication module and a storage module, wherein the wireless communication module can be a wireless receiving module or a wireless transceiver module, which is used for receiving a work schedule data for sent by a mobile terminal and updating the work schedule data to a memory, comprises a Wifi chip and a main chip connected with the Wifi chip through Ethernet, wherein the Wifi chip can receive the information that sent from the mobile terminal through wireless communication, the mobile terminal can be the mobile intelligent device such as smart mobile phone, panel computer and the like that has ios or android system, for example, the user sets or modifies the work schedule of the lawn mowing robot by wireless communicating with the lawn mowing robot through the APP installed on the mobile phone, and the APP send a new work schedule to the Wifi chip on the lawn mowing robot through wireless communication mode. The Wifi chip submits the data to the main chip, the main chip processes the data after receiving the new work schedule, then updates the work schedule in the memory and stores the work schedule to the storage module. Of course, the work schedule data may also be transmitted via a fixed terminal. In the present embodiment, the storage module may be an SD card, and the work schedule data updated to the memory may be stored in the SD card, which facilitates loading the work schedule from the SD card into the main chip memory when the computer is started next time. The wireless communication mode can also be GPRS, WLAN, CDMA, HSPDA, LTE, Bluetooth or infrared, etc.

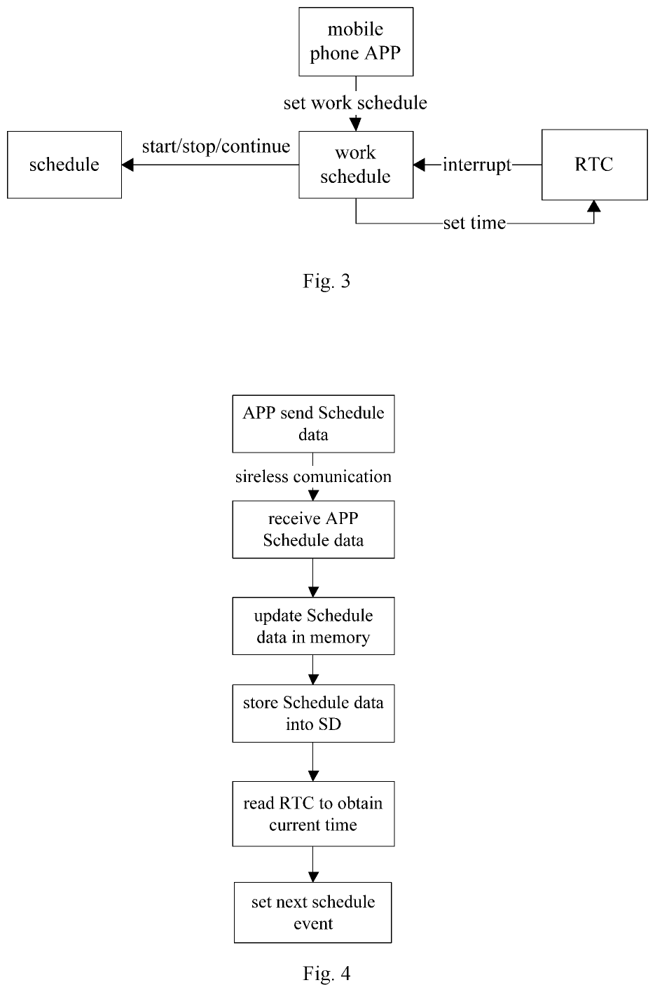

As shown in FIG. 3, the lawn mowing robot further includes an execution strategy generating module, which is used to calculate a latest work prohibited time period and a latest work start time point according to the current time and the updated work schedule data, and set a time point according to the relationship between the latest work prohibited time period and the latest work start time point to trigger a corresponding next work event, and the control module control the robot to execute the next work event according to the next work event generated by the execution strategy generating module. Specifically, the next work event includes a work start event, a work prohibited event, and a work continued event, and the execution strategy generating module may acquire the current time through a Real-Time Clock (RTC). In the present embodiment, the work schedule data comprises the work frequency and the work prohibited time period of the lawn mowing robot, and the work schedule data is generated through a work schedule set by a user, namely, the user's work schedule setting is divided into two parts: 1, the work frequency of the lawn mowing robot; and 2, the work prohibited time period of the lawn mowing robot.

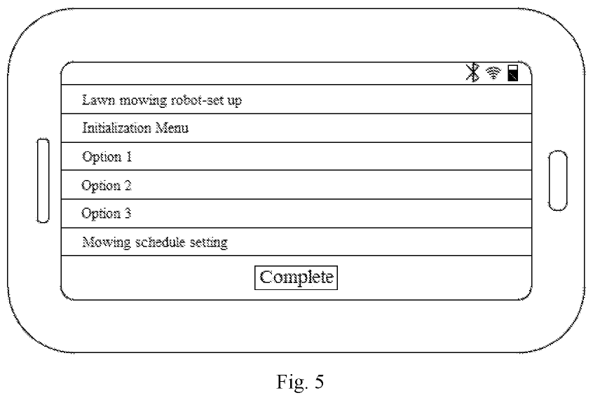

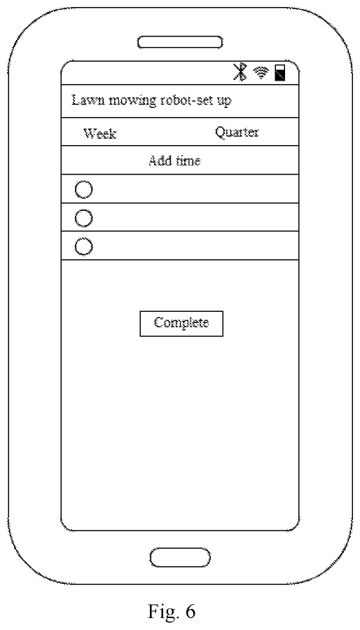

The settings for the work frequency and the work prohibited time period will be described below, respectively. Refer to the display interface on the mobile phone APP shown in FIGS. 5 to 7, according to the display interface in FIG. 5, the mowing schedule setting is selected first, and then the display interface in FIG. 6 is entered. In a first portion, the work frequency of the lawn mowing robot is selected, and two selectable work frequency modes can be available on the menu: “week” and “quarter”. When the “week” mode is activated, the lawn mowing robot will work at a frequency of completing mowing once a week. The user defaults the start time point to AM 0:00 of every Monday when no specific start time is set. Of course, the user can set a specific start time according to their own needs, and the start time can be selected by manually inputting or calling up the clock. When the “quarter” mode is activated, the user may set the lawn mowing robot to work at the same or different mowing frequencies per week in different quarters. And the user sets the corresponding work frequency of the lawn mowing robot in different time periods according to the growth condition of local grass in different time periods. For example, the user needs to work twice a week from January to March, then the quarter can be set as January to March, and the work time can be set as AM 5:00 on Monday and AM 5:00 on Friday, or the quarter can be set as January to March, and the work frequency can be set as twice a week. Of course, the user may also have other settings, such as once every two weeks, once every five days, and so forth. The parameter description for setting the “quarter” mode work frequency can be shown with reference to table \textcircled{1}.

TABLE \textcircled{1}

| | description |
|---|---|
| | (the user defaults to the work time point as follows without setting a |
| set value | specific start time) |
| every day | AM 0:00 every day is the work start time of the lawn mowing robot |
| twice a week | AM 0:00 on every Monday and Thursday is the work start time of the |
| | lawn mowing robot |
| once a week | AM 0:00 on every Monday is the work start time of the lawn mowing |
| | robot |
| twice a month | AM 0:00 on Monday of the first and second week of each month is |
| | the work start time of the lawn mowing robot |
| once a month | AM 0:00 on Monday of the first week of each month is the work start |
| | time of the lawn mowing robot |

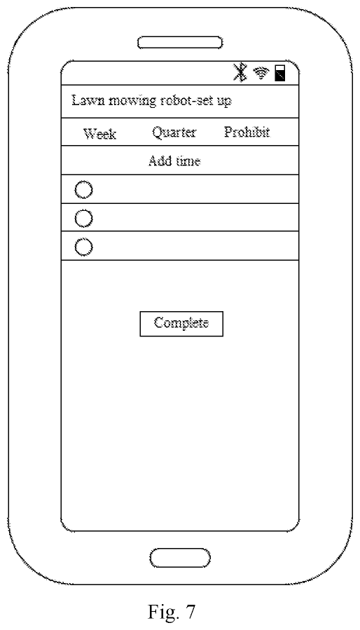

Next, the display interface in FIG. 7 may be entered, and in a second portion, the user may prohibit the lawn mowing robot in a specified period of time by setting “exclusion”. The setting of the work prohibited time period of the lawn mowing robot limits the time period during which the lawn mowing robot can work, and specifies that the lawn mowing robot cannot work in the specific time period. Three settings of the work prohibited time period of the lawn mowing robot can coexist simultaneously: 1. a designated time; 2. a designated time of each week; and 3. a designated time of each month. The designated time can designate a certain time period on a certain day to prohibit work; a designated time per week may designate a specified time period of each week during which work is prohibited; a designated time of each month may designate a designated time of each month during which work is prohibited.

Through the arrangement of the two portions, the lawn mowing robot needs to work according to a time schedule set by the user. As shown in FIG. 2, the robot hardware is initialized firstly, the work schedule data in the SD memory card of the robot is read, the current time of the RTC is read, and the work events (work start event, prohibit work event, continue work event) of the work schedule of the lawn mowing robot are set according to the current time.

For example, in the “week” mode, the lawn mowing robot will start work at the earliest moment of the week, avoiding the non-working time period of the “exclusion” set. Suppose that the lawn mowing robot takes 4 hours to complete one mowing. The “week” mode is activated and the “exclusion” is set as “AM 0:00 to AM 6:00 on Monday” and “AM 8:00 to AM 9:00 on Monday”. Then the lawn mowing robot will begin mowing at AM 6:00 on Monday each week, stop working at AM 8:00 on Monday, continue working at AM 9:00 on Monday, and finish mowing of this week until AM 11:00 on Monday.

In the “quarter” mode, the lawn mowing robot will averagely divide a week into a plurality of parts according to the times of work in one week needed in the quarter of the current date, starting the first work at the earliest moment but avoiding the non-working time period of the “exclusion” set, waiting after finishing this work, until the second work at the earliest moment of this week, and so on. Suppose that the lawn mowing robot takes 4 hours to complete one mowing. The “quarter” mode “twice a week” is activated and the “exclusion” is set to “AM 0:00 on Monday to AM 6:00 on Monday”, and “AM 8:00 on Monday to AM 9:00 on Monday”. The lawn mowing robot will start mowing at AM 6:00 on Monday every week, stop mowing at AM 8:00 on Monday, continue working at AM 9:00 on Monday, and finishing the first mowing task of this week until AM 11:00 on Monday. Then waiting, starting the second mowing work at AM 0:00 on Thursday and finishing the second mowing task at AM 4:00 on Thursday.

Referring to FIG. 4, the above setting can be performed on the terminal device, for example, after a work schedule including a work frequency and a work prohibited time period is set through the mobile phone APP, the work schedule is sent to the lawn mowing robot by the APP, the lawn mowing robot performs data processing on the work schedule and then stores the work schedule into an SD card, reads the current time of the RTC, and sets a work event of the lawn mowing robot at the next step according to the current time.

Next, take a lawn mowing robot as an example to specifically describe the control method of the lawn mowing robot. A user edits the work schedule of the lawn mowing robot on a mobile phone APP, the work schedule is sent through a wireless network after being edited, the lawn mowing robot receives the work schedule data sent by the mobile phone, processes the work schedule data and updates the work schedule data to a memory, then stores the work schedule data in an SD card and obtain the current time, and set the next work event according to the current time and the work schedule data, wherein, the work schedule data comprises at least the work prohibited time period, and the robot can calculate the latest work prohibited time period and the latest work start time point according to the current time and the work schedule data, set a time point corresponding to the latest work prohibited time period or the latest work start time point to trigger a corresponding next work event according to the relationship between the latest work prohibited time period and the latest work start time point, and then control the robot to execute the corresponding next work event according to the current time.

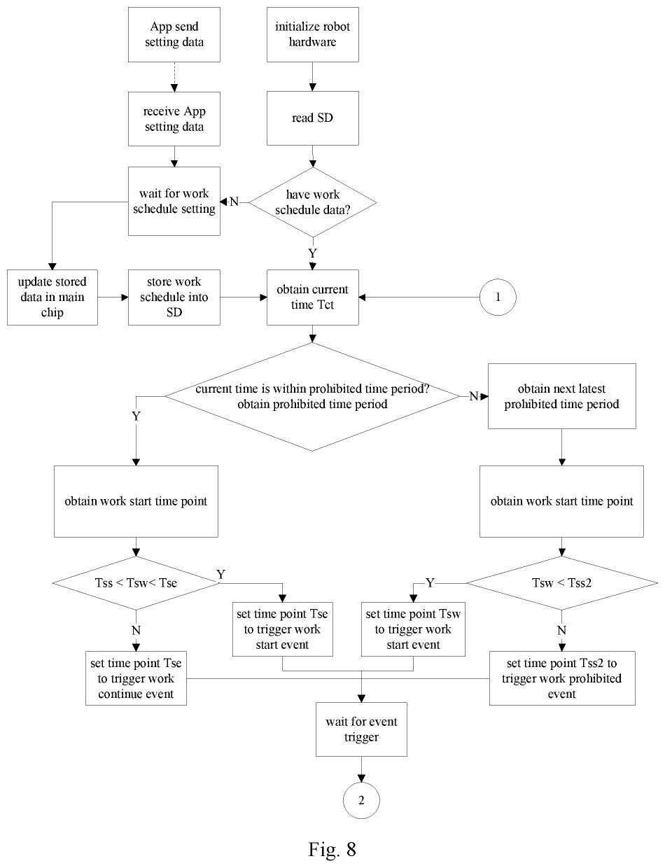

Referring specifically to FIG. 8, the work schedule that needs to be edited by the user includes the work frequency and the work prohibited time period of the lawn mowing robot. Then, when receiving the work schedule data including the work frequency and the work prohibited time period, the lawn mowing robot cannot directly start working, and needs to analyze and judge the data, and then sets a next work event, and the lawn mowing robot executes a task according to the next work event.

When the lawn mowing robot is started, system initialization is needed, including reading of the work schedule data in the SD card, if there is the work schedule data stored in the SD card, the work schedule data are read, the RTC is read to obtain the current time, and then the next work event is set. If there is no work schedule data stored in the SD card, the lawn mowing robot waits for the work schedule to be set.

The work prohibited time period set according to the different states of the robot mower, such as working, standby, charging, etc., may be any time period, so the next work event includes three events of starting work, prohibiting work, and continuing work.

Next, the lawn mowing robot needs to acquire the latest work prohibited time period according to the current time point and the work prohibited time period. There are three kinds of time period: 1. the current time point is in the work prohibited time period; 2. the current time point is before the work prohibited time period; and 3. the current time point is after the work prohibited time period. The determination condition is that the current time Tct is after the start time Tss1 of the work prohibited time period T1 and before the end time Tse1 of the work prohibited time period, and in consideration of the fact that there may be a plurality of work prohibited time periods, it is needed to further simultaneously satisfied that the current time Tct is farthest from the end time Tse1 of the work prohibited time period, then the work prohibited time period T1 is the latest work prohibited time period.

If there is no work prohibited time period which meets the above condition, the next work prohibited time period T2 is acquired as the latest work prohibited time period, that is, the satisfied condition is searched in all the work prohibited time periods, the current time point Tct is before the work prohibited time period T2 and the start time point Tss2 of the work prohibited time period is nearest to the current time point Tct.

It can be seen from the above that, when the latest work prohibited time period is calculated, if the current time point is in a plurality of work prohibited time periods, the work prohibited time period in which the end time point of the work prohibited time period is farthest from the current time point is determined as the latest work prohibited time period; and if the current time point is before the work prohibited time period, the work prohibited time period with the start time point of the work prohibited time period closest to the current time point is determined as the latest work prohibited time period.

In addition, the lawn mowing robot needs to acquire the latest work start time Tsw. The latest work start time Tsw is calculated according to the work frequency, and is searched in all the work start time points. The judgement conditions are that the work start time Tsw is behind the current time point Tct and the work start time Tsw is closest to the current time point Tct.

After acquiring the latest work prohibited time period and the latest work start time point Tsw, the lawn mowing robot needs to set the next work event according to the two parameters. The judgment conditions are as follows: if the work start time Tsw is after the start time Tss1 of the work prohibited time period T1 and before the end time Tse1 of the work prohibited time period, the end time Tse1 is set to trigger the start event, and then the event trigger is waited for; if the work start time Tsw is not within the work prohibited time period T1, the end time Tse1 is set to trigger a continuous work event. The judgment condition may also be: if the work start time point Tsw is before the start time Tss2 of the work prohibited time period T2, the work start time point Tsw is set to trigger a start event and then the event trigger is waited for; if not, the start time Tss2 is set to trigger a work prohibited event.

Specifically, the judgement of whether the latest work start time point is within the latest work prohibited time period has the following several conditions:
a) if the work start time point is within the work prohibited time period and the current time point is within the work prohibited time period, setting the next event as the work start event and the event time point as the end time point of the current work prohibited time period;
b) if the work start time point is within the work prohibited time period and the current time point is not within the work prohibited time period, setting the next event as the work prohibited event and the event time point as the start time point of the latest work prohibited time period;
c) if the work start time point is not within the work prohibited time period and the current time point is within the work prohibited time period, setting the next event as the work continued event and the event time point as the end time point of the latest work prohibited time period;
d) if the work start time point is before the work prohibited time period and the current time point is not within the work prohibited time period, setting the next event as the work start event and the event time point as the work start time point;
e) and if the work start time point is after the work prohibited time period and the current time point is not within the work prohibited time period, setting the next event as the work prohibition event and the event time point as the start time point of the latest work prohibited time period.

The above b) and e) may be combined into a judgment that if the operation start time point is not before the work prohibited time period and the current time point is not within the work prohibited time period, setting the next event as the work prohibited event and the event time point as the start time point of the latest work prohibited time period.

Examples are as follows:

| | | the latest work | the latest work start | |
|---|---|---|---|---|
| conditions | current time | prohibited time period | time point | result |
| a | PM 10:00 on | PM 9:00 on Wednesday | AM 0:00 on | start work event at |
| | Wednesday | to AM 1:00 on Thursday | Thursday | AM 1:00 on |
| | | | | Thursday |
| c | PM 10:00 on | PM 9:00 on Wednesday | AM 0:00am on | continue work |
| | Wednesday | to PM 12:00 on | Thursday | event at PM 12:00 |
| | | Wednesday | | on Wednesday |
| d | PM 8:00 on | AM 1:00 on Thursday to | AM 0:00am on | start work event at |
| | Wednesday | AM 2:00 on Thursday | Thursday | AM 0:00 on |
| | | | | Thursday |
| b | PM 8:00 on | PM 9:00 on Thursday to | AM 0:00am on | prohibit work event |
| | Wednesday | AM 1:00 on Thursday | Thursday | at PM 9:00 on |
| | | | | Wednesday |
| e | PM 8:00 on | PM 9:00 on Thursday to | AM 0:00am on | prohibit work event |
| | Wednesday | PM 11:00 on | Thursday | at PM 9:00 on |
| | | Wednesday | | Wednesday |

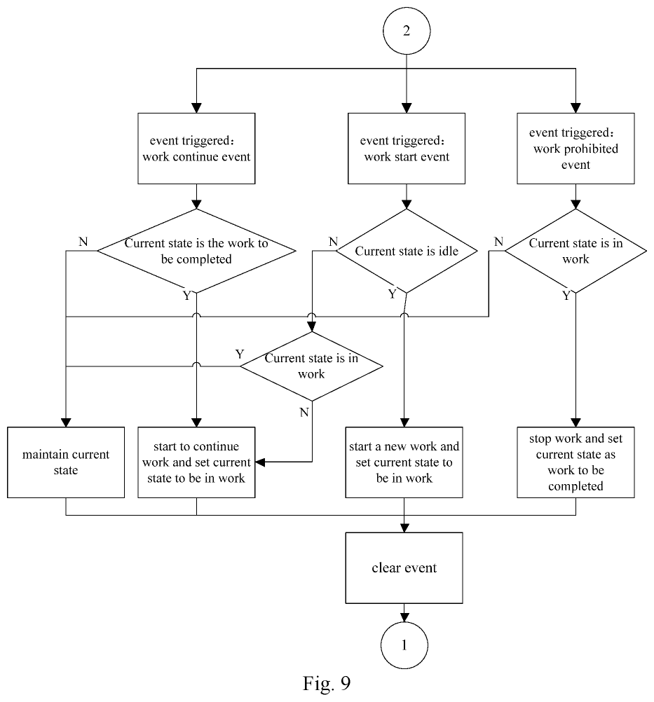

Next, the flow of event triggering is described in detail, as shown in FIG. 9, the next work event includes a work continued event, a work start event, and a work prohibited event, so that the lawn mowing robot has three working states: 1. in operation (is performing work); 2. work to be completed (work not completed and currently work prohibited time); and 3. idle (work completed and no other work tasks).

If the triggered event is a continuous work event, judging whether the current state is that the work is to be finished, if so, starting to continue work, and setting the state to be in work; if not, maintaining the current state.

If the triggered event is a work start event, judging whether the current state is idle, if so, starting a new work, setting the state as in work, clearing the event, and returning to a program for setting the next work event; if not, continuously judging whether the current state is in work, if so, keeping the current state; if not, starting to continue work, and setting the state to be in work.

If the triggered event is a work prohibited event, judging whether the current state is in work, if so, stopping working, and setting the state as work to be completed; if not, maintaining the current state.

By the above control method, the work time of the robot is set more conveniently, and meanwhile, the robot has higher processing speed, occupies smaller memory and has lower cost, thereby better meeting the requirements of users.

In a preferred embodiment of the present disclosure, the robot comprises: a wireless receiving module used for receiving work schedule data containing a work prohibited time period and updating the same to a memory; a storage module used for storing the work schedule data updated to the memory; an execution strategy generating module used for calculating, according to the current time and the work schedule data, a latest work prohibited time period and a latest work start time point, and setting a time point to trigger a corresponding next work event according to the relationship between the latest work prohibited time period and the latest work start time point; and a control module used for controlling the robot to execute the corresponding next work event according to the current time. These modules are divided by function and may be considered as virtual modules. If divided in terms of hardware, the robot includes a memory configured to store program instructions of the control method as described previously; and a processor configured to execute the program instructions.

It should be understood that although the specification describes embodiments, not every embodiment includes only a single independent technical solution, and such description is only for the sake of clarity. Those skilled in the art should take the specification as a whole, and the technical solutions in each embodiment can be properly combined to form other embodiments that can be understood by those skilled in the art.

The above-listed detailed description is merely a detailed description of possible embodiments of the present disclosure, and it is not intended to limit the scope of the disclosure, and equivalent embodiments or modifications made without departing from the technical spirit of the present disclosure are intended to be included within the scope of the present disclosure.

1. A control method of a robot, comprising the steps of:
receiving work schedule data containing a work prohibited time period and updating the same to a memory;
storing the work schedule data updated to the memory;
calculating, according to the current time and the work schedule data, a latest work prohibited time period and a latest work start time point;
setting a time point to trigger a corresponding next work event according to the relation between the latest work prohibited time period and the latest work start time point; and
controlling the robot to execute the corresponding next work event.

2. The control method of a robot according to claim 1, wherein the work schedule data further includes a robot work frequency.

3. The control method of a robot according to claim 2, wherein the latest work prohibited time period is acquired based on the current time and the work prohibited time period.

4. The control method of a robot according to claim 3, wherein in the step of calculating the latest work prohibited time periods, if the current time point is within a plurality of work prohibited time periods, the work prohibited time period in which the end time point of the work prohibited time period is farthest from the current time point is determined as the latest work prohibited time period.

5. The control method of a robot according to claim 3, wherein in the step of calculating the latest work prohibited time period, if the current time point is before the work prohibited time period, the work prohibited time period in which the start time point of the work prohibited time period is closest to the current time point is determined as the latest work prohibited time period.

6. The control method of a robot according to claim 5, wherein the latest work start time point is obtained according to the current time and the work frequency.

7. The control method of a robot according to claim 6, wherein in the step of calculating the latest work start time point, the work start time point which is after the current time point and is closest to the current time point is determined as the latest work start time point.

8. The control method of a robot according to claim 7, wherein after the latest work prohibited time period and the latest work start time point are obtained, the control method further includes a step of determining whether the latest work start time point is within the latest work prohibited time period, if so, setting an end time point of the latest work prohibited time period to trigger a corresponding next work event as a work start event and waiting for an event trigger; if not, setting the end time point of the latest work prohibited time period to trigger the corresponding next work event as a continuous work event.

9. The control method of a robot according to claim 8, wherein after the next work event is set to be a continuous work event, the control method further includes a step of triggering the continuous work event, first, judging whether the current state is to be finished, if so, starting the continuous work, and setting the state to be in work; if not, maintaining the current state.

10. The control method of a robot according to claim 7, wherein after obtaining the latest work prohibited time period and the latest work start time point, the control method further includes a step of determining whether the latest work start time point is before the start time point of the latest work prohibited time period, if so, setting the latest work start time point to trigger a corresponding next work event as a work start event and waiting for an event trigger; if not, setting the start time point of the latest work prohibited time period to trigger the corresponding next work event as a work prohibited event.

11. The control method of a robot according to claim 10, wherein after the next work event is set to be a work prohibited event, the control method further includes a step of triggering the work prohibited event, first, determining whether the current state is in work, if so, stopping working, and setting the state as the work to be completed; if not, maintaining the current state.

12. The control method of a robot according to claim 10, wherein after the next work event is set as a work start event, the control method further includes a step of triggering the work start event, first, determining whether the current state is idle, if so, starting a new work, setting the state to be in work, clearing the event, and returning to the program for setting the next work event; if not, continuously judging whether the current state is in work, if so, maintaining the current state; if not, continuing the work, and setting the state to be in work.

13. A robot, comprising a memorizer configured to store program instructions of the control method according to claim 1, and a processor configured to execute the program instructions.

14-24. (canceled)
